(19) United States
(12) Patent Application Publication
(10) Pub. No.: US 2007/0267835 A1
(43) Pub. Date: Nov. 22, 2007

(54) Foldable walker frame

(75) Inventor: Pao Shan Huang, Tai-Bau City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Link Treasure Limited, Road Town (VG)

(21) Appl. No.: 11/804,245

(22) Filed: May 17, 2007

(30) Foreign Application Priority Data
May 19, 2006 (TW) 095208668

(51) Int. Cl. B62M 1/00

(52) U.S. Cl. 280/87.05

(57) ABSTRACT

A foldable walker frame has a pair of handle struts, a foldable rack, a lateral folding mechanism, a pair of leg struts and a pair of latch elements. The pair of handle struts each has a handle, a braking actuator, and a connecting element. The lateral folding mechanism is pivotally connected between the pair of handle struts for separating the handle struts in an erected position and carrying the handle struts to close to each other in a folded position. The connecting element connects a front wheel and pivotally connects the leg struts, this allows the leg struts to pivot about the pivot pin and close to the handle struts in a collapsed state. The latch elements is linearly and slidably connected within one end of the leg struts, so as to latch to the connecting element and therefore stop the leg struts from rotation in an erected position.

This application claims priority of Taiwan Patent Application No. 095208668 filed in Taiwan, R.O.C. on May 19, 2006 under 35 U.S.C. §119, the entire contents of which are hereby incorporated by reference.

### BACKGROUND OF THE INVENTION

1. Field of the Invention

The present invention relates to a foldable walker frame and, in particular, to a foldable walker frame having a frame and a foldable rack that both are foldable simultaneously for easy transportation and storage.

2. Description of the Related Art

After World War II, many countries underwent a baby boom, i.e., a temporary period of increased birth rates. Now that several decades have passed, these baby boomers are aging, resulting in a higher percentage of elderly people in the general population, whereby the elderly are now a major consumer group. Accordingly, many products are designed to meet the demands of an elderly population, such as walking aids which can help support the elderly or infirm while walking.

A conventional walker is used to increase safety and steadiness for the elderly or infirm while walking. Unlike a cane, a walker is configured as an inverse-U shape so that the elderly or infirm can easily be positioned in the middle of the walker, thereby providing more stable support than a cane. However, the frame of a walker takes up more space than a cane, and may therefore not be convenient for carrying or storage, whether long term or temporary.

### SUMMARY OF THE INVENTION

One aspect of the present invention is to overcome the shortcomings of the walkers found in the prior art, and provide a foldable rack to a walker frame that is foldable in both lateral and longitudinal direction.

The foldable walker frame according to the present invention has a pair of handle struts, a foldable rack, a lateral folding mechanism, a pair of leg struts and a pair of latch elements. Each of the pair of handle struts has a handle, a braking actuator, and a connecting element. The lateral folding mechanism is pivotally connected between the pair of handle struts for separating the handle struts in an erected position and carrying the handle struts to close to each other in a folded position. The connecting element connects a front wheel and pivotally connects the leg struts, which allows the leg struts to pivot about the pivot pin and close to the handle struts in a collapsed state. The latch elements is linearly and slidably connected within one end of the leg struts, so as to latch to the connecting element and therefore stop the leg struts from rotation in an erected position.

These and other aspects of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by way of illustration only, and thus are not limitative of the present invention, and wherein:

FIG. 1 is a perspective view of an embodiment of the present invention in an erected state.

FIG. 2 is a rear planar view showing the lateral foldable elements, including the foldable rack, the pair of articulated connecting arms, and scissor link assembly.

FIG. 3 is an exploded side view showing the connection relation between the handle strut, latch element, and the leg strut.

FIG. 4 is a side partially enlarged view showing the operation of the latch element in a latched position.

FIG. 5 is an enlarged cross-sectional view showing the release operation of the latch element.

FIG. 6 is a schematically view showing the folding operation of the leg strut.

FIG. 7 is a schematically view showing the foldable walker frame of FIG. 1 in a folded state.

### DETAILED DESCRIPTION OF THE PREFERRED EMBODIMENTS

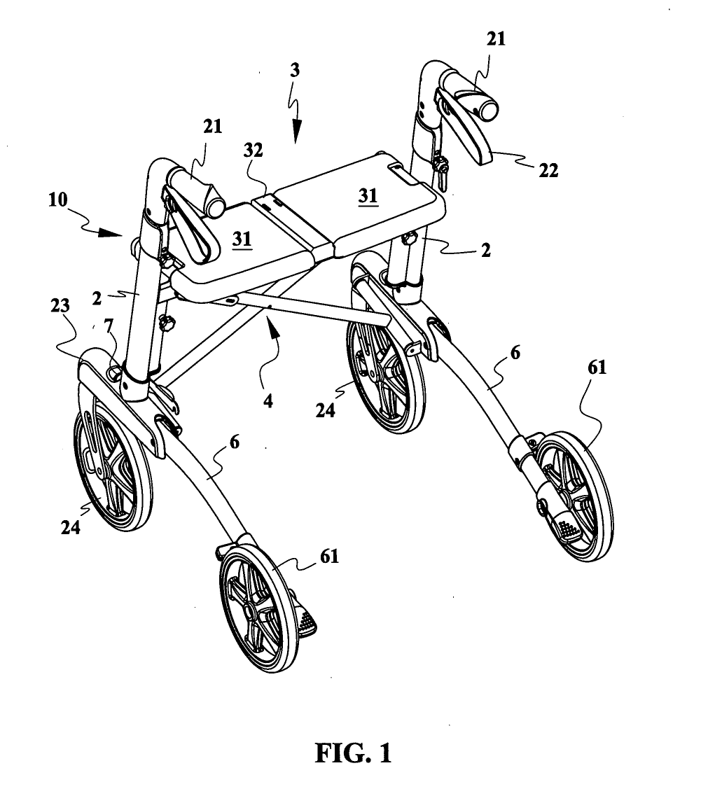

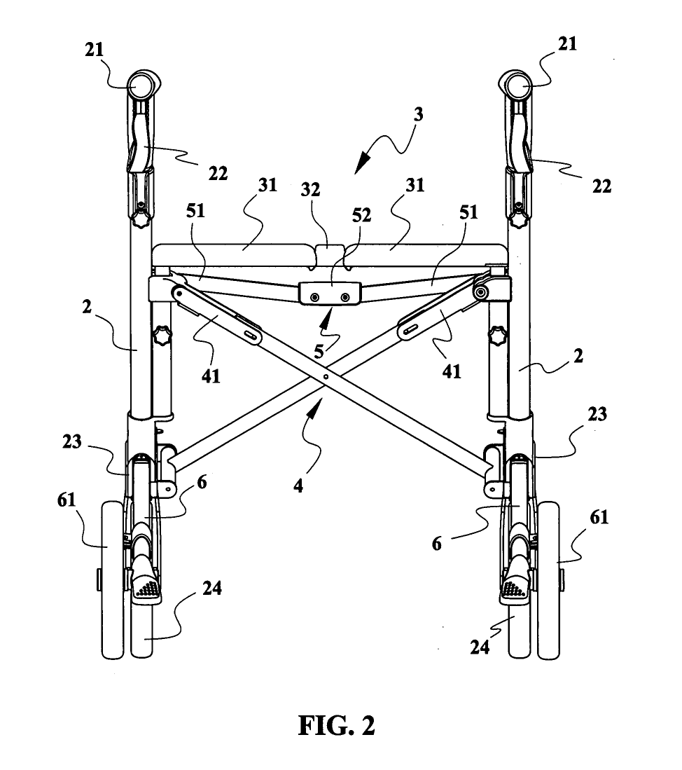

Referring to FIGS. 1 and 2, an embodiment of a foldable walker frame 10 is shown, which includes a pair of handle struts 2, a foldable rack 3, a lateral folding mechanism, a pair of leg struts 6 and a pair of latch elements 7.

The leg struts 6 each has one end pivotally connected with the connecting element 23 by a pivot pin 232, and another end connected with a rear wheel 61.

The pair of handle struts 2 can be a pair of telescopic pipes for adjusting its length or height, each connects a handle 21, a braking actuator 22, and a connecting element 23. The handle 21 is connected at the upper end of the handle struts 2. The braking actuator 22 is pivotally connected with the handle 21 for controlling a braking device (not shown) of the foldable walker frame 10.

The foldable rack 3 has a pair of rack plates 31 which are pivoted with each other by a hinge member 32. The foldable rack 3 is pivotally connected between the pair of handle struts 2 and foldable to carry the pair of handle struts 2 to close to each other.

The lateral folding mechanism is pivotally connected between the pair of handle struts 2 for separating the handle struts 2 in an erected position and carrying the handle struts 2 to close to each other in a folded position. Preferably, The lateral folding mechanism may include a scissor link assembly 4, or a pair of articulated connecting arms 5, or the both.

The pair of articulated connecting arms 5 may include a pair of pivotal arms 51 and a joint 52. The pair of pivotal arms 51 each has one end pivotally connected with the joint 52, and another end pivotally connected with the pair of handle struts 2. When the joint is lifted by a user, this carries the pair of pivotal arms 51 to rotate and carry the pair of handle struts 2 to close to each other.

The scissor link assembly 4 may pivotally connect the pair of handle struts 2 at the lower ends, and pivotally connects to the pair of handle struts 2 at the upper ends by a pair of pivotal arms 41.

The connecting element 23 is connected at the lower end of the connecting element 23, having front wheel 24, a positioning pin 231 and a pivot pin 232, and a upper opening 233.

The front wheel 24 is pivotally connected at the front end of the connecting element 23 by a bracket 241.

The positioning pin 231 is laterally mounted inside the connecting element 23.

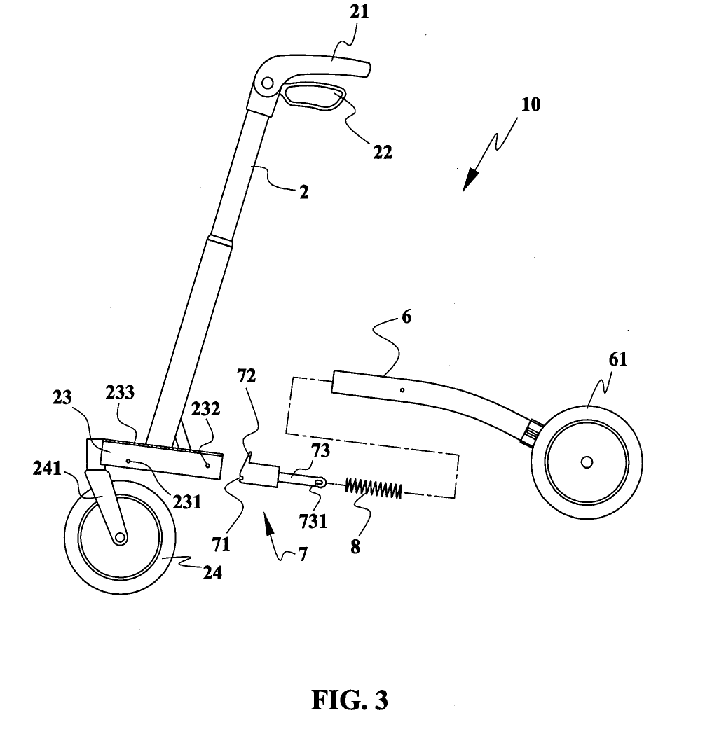

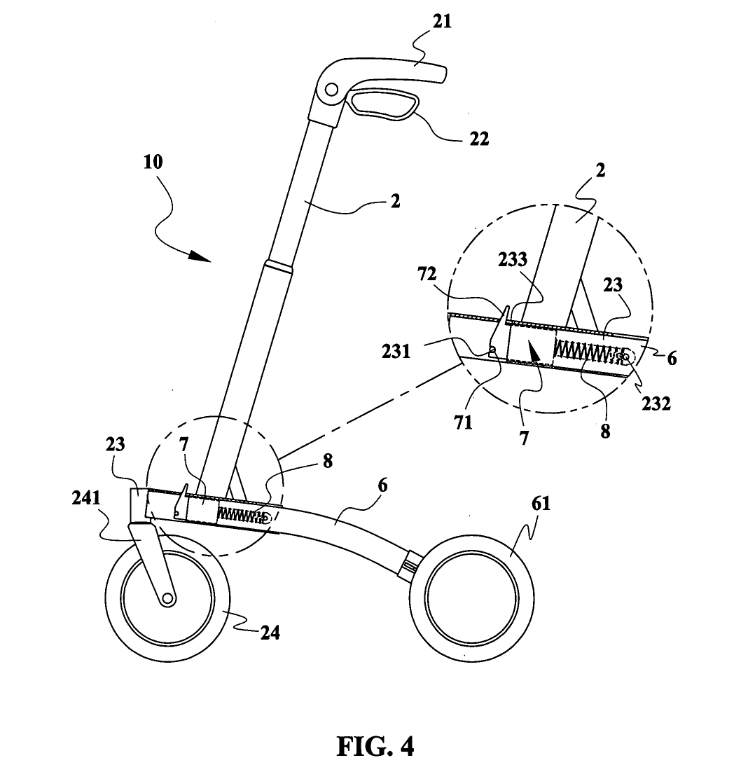

Referring to FIGS. 3 and 4, the latch element 7 has a notch 71, an extending portion 72, and a shank 73. The shank 73 of the latch element 7 is formed with a guiding slot 731 for receiving the pivot pin 232. The pivot pin 232 has two ends for extending through the guiding slot 731 and pivotally connected the leg strut 6 to the connecting element 23, this allows the latch element 7 can be driven forward and backward.

A resilient element 8 is mounted around the shank 73 for biasing the latch element 7 moving against the positioning pin 231. By this arrangement, the notch 71 of the latch element 7 is kept in engagement with the positioning pin 231, therefore, to lock the leg strut 6 in an erected position.

In this embodiment, the resilient element 8 may be a spring, for instance, a compression spring.

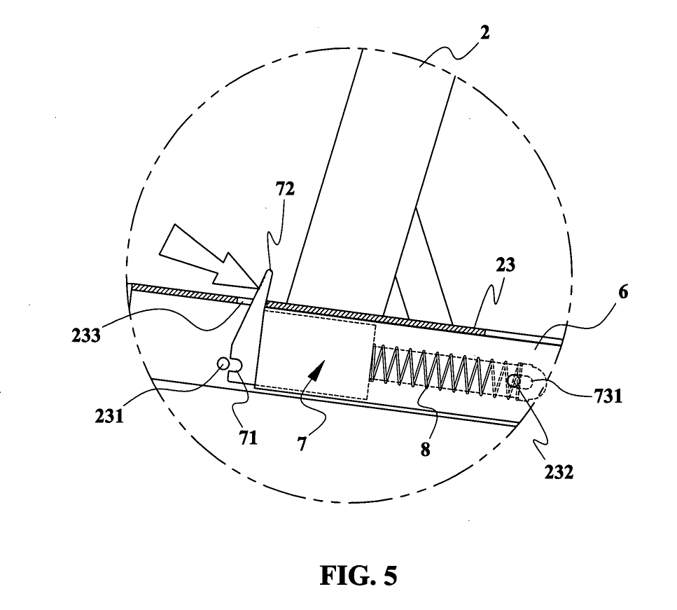

Referring to FIG. 5, as the extending portion 72 of the latch element 7 is extended through the upper opening 233 of the connecting element 23, a user can release the latch element 7 from the positioning pin 231 by pushing the extending portion 72, so as to force the latch element 7 moving backward against the biasing of the resilient element 8.

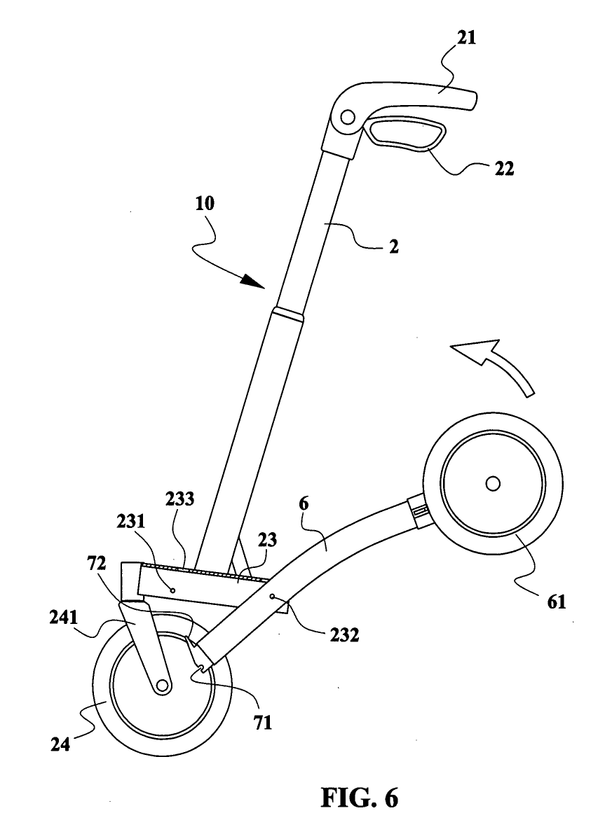

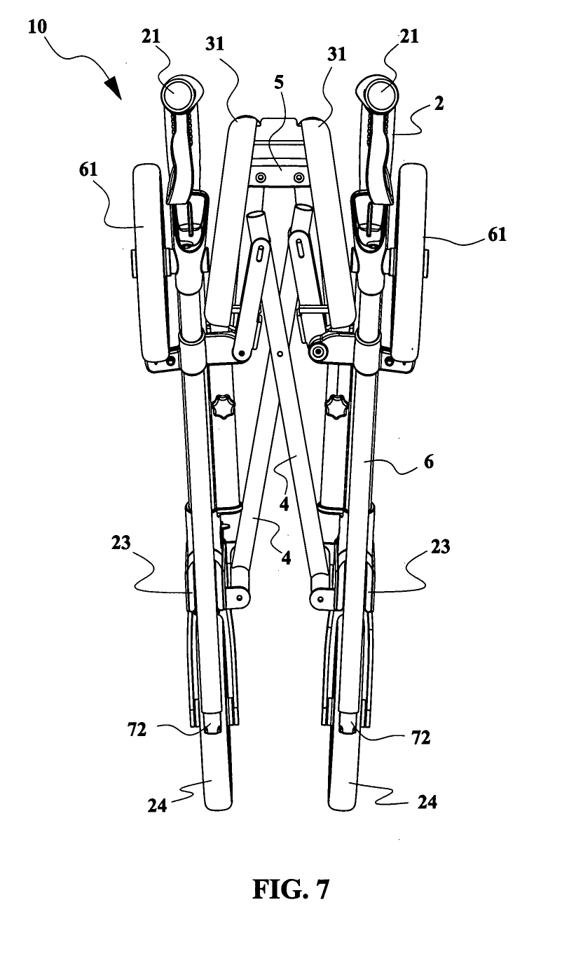

Referring to FIGS. 6 and 7, when the latch element 7 is released by pushing the extending portion 72, the leg strut 6 can rotate and close to the handle struts 2. In the meantime, the foldable rack 3 and the lateral folding mechanism including the scissor link assembly 4 and/or the pair of articulated connecting arms 5 can associately carry the handle struts 2 to close to each other.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A foldable walker frame, comprising:
a pair of handle struts, each having a handle mounted at the upper end thereof;
a pair of connecting elements, each connecting a front wheel, a positioning pin, and a pivot pin;
a pair of leg struts, each having one end connecting a rear wheel, and another end pivoted with the connecting elements by the pivot pin;
a pair of latch elements, each having a notch for engaging with the positioning pin of the connecting elements, an extending portion for pushing by a user, and a shank with a guiding slot for movably connected within the leg struts;
a pair of resilient elements mounted around the shank for biasing the latch elements to engage with the positioning pin at the notch, so as to lock the pair of leg struts in an erected position;
a foldable rack, pivotally connected between the pair of leg struts, having a pair of rack plates connected by a hinge member;
a pair of articulated connected arms, pivotally connected between the pair of leg struts, having a pair of pivotal arms connected by a joint; and
a scissor link assembly, connected between the pair of leg struts.

2. The foldable walker frame of claim 1, wherein the pair of connecting elements each has a upper opening, and the extending portion is extending through the upper opening.

3. The foldable walker frame of claim 1, wherein the pair of leg struts are a pair of telescopic pipes.

4. The foldable walker frame of claim 1, wherein the pivot pin has two ends extended from the guiding slot of the shank of the latch element.

5. The foldable walker frame of claim 4, wherein the pivot pin has two ends extends from the guiding slot of the shank of the latch element, so as to pivot the leg struts to the connecting elements.

6. The foldable walker frame of claim 1, wherein the connecting element connects the front wheel by a bracket.

7. The foldable walker frame of claim 1, wherein the resilient element is a compression spring.

8. A foldable walker frame, comprising:
a pair of handle struts, each having a handle at the upper end thereof;
a pair of connecting elements, each connecting a front wheel, a positioning pin, and a pivot pin;
a pair of leg struts, each having one end connecting a rear wheel, and another end pivoted with the connecting elements by the pivot pin;
a pair of latch elements, each having a notch for engaging with the positioning pin of the connecting elements, an extending portion for pushing by a user, and a shank with a guiding slot for movably connected within the leg struts;
a pair of resilient elements mounted around the shank for biasing the latch elements to engage with the positioning pin via the notch, so as to lock the pair of leg struts in an erected position;
a foldable rack, pivotally connected between the pair of leg struts, having a pair of rack plates connected by a hinge member; and
a lateral folding mechanism, pivotally connected between the pair of handle struts.

9. The foldable walker frame of claim 8, wherein the lateral folding mechanism is a scissor link assembly, pivotally connected between the pair of handle struts.

10. The foldable walker frame of claim 8, wherein the lateral folding mechanism is a pair of articulated connecting arms, pivotally connected between the pair of handle struts.

11. The foldable walker frame of claim 8, wherein the pair of leg struts are locked in an erected position by the pair of latch elements, and are rotatable about the pivot pin to close to the pair of handle struts in a folded position.

12. The foldable walker frame of claim 8, wherein the pair of connecting elements, each has a upper opening, and the extending portion is extending through the upper opening.

13. The foldable walker frame of claim 8, wherein the pair of leg struts are a pair of telescopic pipes.

14. The foldable walker frame of claim 8, wherein the pivot pin has two ends extended from the guiding slot of the shank of the latch element.

15. The foldable walker frame of claim 14, wherein the pivot pin has two ends extends from the guiding slot of the shank of the latch element, so as to pivot the leg struts to the connecting elements.

16. The foldable walker frame of claim 8, wherein the connecting element connects the front wheel by a bracket.
